(19) United States
(12) Patent Application Publication
(10) Pub. No.: US 2025/0081150 A1
(43) Pub. Date: Mar. 6, 2025

(54) METHOD UE INDICATION OF PRS MEASUREMENT MODE

(71) Applicant: Nokia Technologies Oy, Espoo (FI)

(72) Inventors: Ryan KEATING, Naperville, IL (US); Tao TAO, Shanghai (CN); Hyun-Su CHA, Naperville, IL (US)

(21) Appl. No.: 18/682,863

(22) PCT Filed: Sep. 29, 2021
(86) PCT No.: PCT/CN2021/121975

§ 371 Date: Feb. 9, 2024

(51) Int. Cl. H04W 64/00; H04W 24/08

(52) U.S. Cl. CPC H04W 64/00; H04W 24/08

(57) ABSTRACT

In accordance with example embodiments of the invention there is at least a method and apparatus to perform at least sending, by a network device, information comprising a request for positioning reference signals from a network node of a communication network, wherein the request comprises information on an ability of the network device to receive one or more of the positioning reference signals in at least one of a measurement gap based mode or without a measurement gap based mode; and based on the request, receiving from the network node information comprising one or more sets of positioning reference signals. Further, to perform receiving, by a network node, from a network device of a communication network information comprising a request for positioning reference signals; based on the request, determining at least one configuration of positioning reference signal configurations, wherein the at least one configuration comprises one or more sets of positioning reference signals in at least one mode comprising a measurement gap based mode or without a measurement gap based mode for different ones of the positioning reference signals; and sending by the network node towards the network device information comprising the one or more sets of positioning reference signals.

### TECHNICAL FIELD

The teachings in accordance with the exemplary embodiments of this invention relate generally to positioning reference signal provisioning and, more specifically, relate to downlink positioning reference signal provisioning with or without a measurement gap.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
BWP Bandwidth Part
gNB 5G Base Station
LPP LTE Positioning Protocol
LMC Local Location Management Component
LMF Location Management Function
MG Measurement Gap
NR New Radio (5G)
NRPPa New Radio Positioning Protocol A
ODPRS On-demand PRS
PRS Positioning Reference Signal
QoS Quality of Service
RRM Radio Resource Management
TRP Transmission Reception Point
UE User Equipment

In standards meeting at the time of this application there have been work items for study enhancements and solutions to support the high accuracy (horizontal and vertical), low latency, network efficiency (scalability, RS overhead, etc.), and device efficiency (power consumption, complexity, etc.) requirements for commercial uses cases (incl. general commercial use cases and specifically (I)IoT use cases. In at least one such work item a UE is always expected to be configured with measurement gaps (MG) when performing positioning measurements, such as with positioning reference signaling.

In such work items, for the purpose of latency reduction it is unavoidable to support Positioning Reference Signal (PRS) measurement without MG, and 3GPP RAN1 has been actively considering several detailed options to effectively support it. One factor that is under discussion in RAN1 in relation to MG-less positioning is the UE behavior with relation to other downlink (DL) signals/channels.

The UEs ability to measure and process the PRS in a MG-less mode is dependent on the current traffic to/from the UE and other constraints on the UE (e.g., RRM measurements). This information is currently not available at the location server (LMF) due to the transparent nature of the LTE Positioning Protocol (LPP). Therefore, at the time of this application the LMF has no knowledge of if the current situation is a good one or not for a UE to measure and process a DL PRS in a MG-less mode even if the UE in principle supports a MG-less mode. The LMF also does not have knowledge about the active bandwidth part (BWP) of the UE and therefore doesn't know if a particular PRS configuration will require the UE to switch BWP (which may mean the UE is unable to measure the PRS in MG-less mode).

In downlink positioning techniques such as downlink time difference of arrival and downlink angle of departure the UE measures the PRS from multiple gNBs. The UE measures for example the reference signal time difference (RSTD) or reference signal received power (PRS-RSRP). Those measurements are then used to assist in estimating the location of the UE. The UE may report those measurements to the LMF if the LMF is the entity estimating the location. In downlink and uplink positioning technique, the UE measures the time difference between reception time of PRS and transmission time of SRS (Sounding Reference Signals) from multiple TRPs or gNBs. The UE may report those measurements to the LMF.

Example embodiments of the invention as disclosed herein work address at least some of these issues to improve such PRS related operations.

### SUMMARY

This section contains examples of possible implementations and is not meant to be limiting.

In an example aspect of the invention, there is an apparatus, such as a user equipment apparatus, comprising: at least one processor; and at least one memory including computer program code, where the at least one memory and the computer program code are configured, with the at least one processor, to cause the apparatus to at least: send, by a network device, information comprising a request for positioning reference signals from a network node of a communication network, wherein the request comprises information on an ability of the network device to receive one or more of the positioning reference signals in at least one of a measurement gap based mode or without a measurement gap based mode; and based on the request, receive from the network node information comprising one or more sets of positioning reference signals.

In another example aspect of the invention, there is a method comprising: sending, by a network device, information comprising a request for positioning reference signals from a network node of a communication network, wherein the request comprises information on an ability of the network device to receive one or more of the positioning reference signals in at least one of a measurement gap based mode or without a measurement gap based mode; and based on the request, receiving from the network node information comprising one or more sets of positioning reference signals.

A further example embodiment is an apparatus and a method comprising the apparatus and the method of the previous paragraph, wherein the received one or more sets of positioning reference signals comprises based on a request from the network device at least one of a positioning reference signal in a measurement gap based mode and a positioning reference signal without a measurement gap based mode, wherein the information comprises an indication of a downlink positioning reference signal processing window that the network device will use for processing a positioning reference signal without a measurement gap based mode, wherein the information comprises an indication of a purpose of the positioning reference signals, and wherein the indicated purpose of the positioning reference signals is for at least one of an accuracy, latency, or a complexity associated with the positioning reference signals, wherein the at least one non-transitory memory including the computer program code is configured with the at least one processor to cause the apparatus to measure by the network device the one or more sets of positioning reference signals in either the measurement gap based mode or without a measurement gap based mode, wherein the at least one mode for the different ones of the positioning reference signals is based on at least one of: current scheduling constraints/data activity, positioning reference signal processing capability, positioning reference signal bandwidth, current active downlink bandwidth part, periodicity of PRS, periodicity of measurement gap pattern, periodicity of downlink PRS signal processing window, number of PRS measurement samples, or downlink positioning reference signal processing window, and/or wherein the request for positioning reference signals request comprises a request for on-demand positioning reference signals.

A non-transitory computer-readable medium storing program code, the program code executed by at least one processor to perform at least the method as described in the paragraphs above.

In another example aspect of the invention, there is an apparatus comprising: means for sending, by a network device, information comprising a request for positioning reference signals from a network node of a communication network, wherein the request comprises information on an ability of the network device to receive one or more of the positioning reference signals in at least one of a measurement gap based mode or without a measurement gap based mode; and means, based on the request, for receiving from the network node information comprising one or more sets of positioning reference signals.

In accordance with the example embodiments as described in the paragraph above, at least the means for sending and receiving comprises a network interface, and computer program code stored on a computer-readable medium and executed by at least one processor.

In an example aspect of the invention, there is an apparatus, such as a network side apparatus, comprising: at least one processor; and at least one memory including computer program code, where the at least one memory and the computer program code are configured, with the at least one processor, to cause the apparatus to at least: receive, by a network node, from a network device of a communication network information comprising a request for positioning reference signals; based on the request, determine at least one configuration of positioning reference signal configurations, wherein the at least one configuration comprises one or more sets of positioning reference signals in at least one mode comprising a measurement gap based mode or without a measurement gap based mode for different ones of the positioning reference signals; and send by the network node towards the network device information comprising the one or more sets of positioning reference signals.

In another example aspect of the invention, there is a method comprising: receiving, by a network node, from a network device of a communication network information comprising a request for positioning reference signals; based on the request, determining at least one configuration of positioning reference signal configurations, wherein the at least one configuration comprises one or more sets of positioning reference signals in at least one mode comprising a measurement gap based mode or without a measurement gap based mode for different ones of the positioning reference signals; and sending by the network node towards the network device information comprising the one or more sets of positioning reference signals.

A further example embodiment is an apparatus and a method comprising the apparatus and the method of the previous paragraph, wherein the request comprises information on an ability of the network device to receive one or more of the positioning reference signals in at least one of a measurement gap based mode or without a measurement gap based mode, wherein the information comprises an indication of a downlink positioning reference signal processing window to be used by the network device for processing a positioning reference signal without a measurement gap based mode, wherein the information comprises an indication of a purpose of the positioning reference signals, and wherein the indicated purpose of the positioning reference signals is for at least one of an accuracy, latency, or a complexity associated with the positioning reference signals, wherein determine at least one configuration comprises determining an optimal positioning reference signal configuration with a lowest latency based on the at least one mode comprising the measurement gap based mode or without the measurement gap based mode for different ones of the positioning reference signals, and/or wherein the request for positioning reference signals from the network device are based on positioning reference signals in at least one of a measurement gap based mode or without a measurement gap based mode predetermined by the network node for the network device.

A non-transitory computer-readable medium storing program code, the program code executed by at least one processor to perform at least the method as described in the paragraphs above.

In another example aspect of the invention, there is an apparatus comprising: means for receiving, by a network node, from a network device of a communication network information comprising a request for positioning reference signals; means, based on the request, for determining at least one configuration of positioning reference signal configurations, wherein the at least one configuration comprises one or more sets of positioning reference signals in at least one mode comprising a measurement gap based mode or without a measurement gap based mode for different ones of the positioning reference signals; and means for sending by the network node towards the network device information comprising the one or more sets of positioning reference signals.

In accordance with the example embodiments as described in the paragraph above, at least the means for receiving, determining, and sending comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an overall signaling flow of example embodiments of the invention;

FIG. 2 shows a high-level block diagram of various devices used in carrying out various aspects of the invention; and

FIG. 3A and FIG. 3B each show a method in accordance with example embodiments of the invention which may be performed by an apparatus.

### DETAILED DESCRIPTION

Example embodiments of the invention relate to downlink positioning reference signal provisioning with or without a measurement gap. Example embodiments of the invention apply to any type of reference signal such as PRS used for positioning.

Example embodiments of the invention proposes at least a method and apparatus for a UE to indicate a preference for DL PRS reception with or without a measurement gap and appropriately configure an on-demand PRS, and for a network node such as a base station to provide configurations to the UE for DL PRS reception with or without a measurement gap and appropriately configure an on-demand PRS.

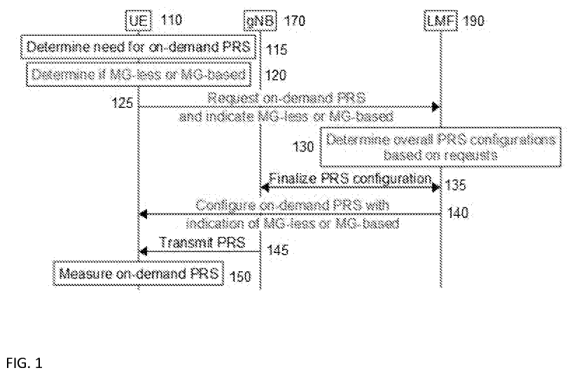

FIG. 1 shows the overall signaling flow of example embodiments of the invention. FIG. 1 shows operations between a UE 110, gNB 170, and LMF 190 in accordance with example embodiments of the invention.

As shown in step 115 of FIG. 1 there is determining by the UE 110 a need for on-demand PRS. As shown in step 120 of FIG. 1 the UE 110 is determining whether the PRS could be MG-less or MG-based. As shown in step 125 of FIG. 1 the UE 110 is communicating towards the network (e.g., the LMF 190 as in FIG. 1) a request for on-demand PRS and indicating MG-less or MG-based requirements. As shown in step 130 of FIG. 1 the LMF 190 is determining overall PRS configurations based on the request(s). As shown in step 135 if FIG. 1 the LMF 190 and the gNB 170 finalize the PRS configuration. This step 135 can include the LMF requesting the PRS configuration and the gNB(s) determining if they accept that request or not. As shown in step 140 of FIG. 1 the LMF 190 communicates with the UE 110 a configured on-demand PRS with an indication of MG-less or MG-based PRS. As shown in step 145 of FIG. 1 the gNB 170 transmits the PRS towards the UE 110 as in FIG. 1. Then as shown in step 150 of FIG. 1 the UE 110 measures on-demand PRS.

It is noted that the LMF may be implemented in a core network or in a radio access network (RAN). Further, if implemented in RAN then the LMF may be called a local management component (LMC).

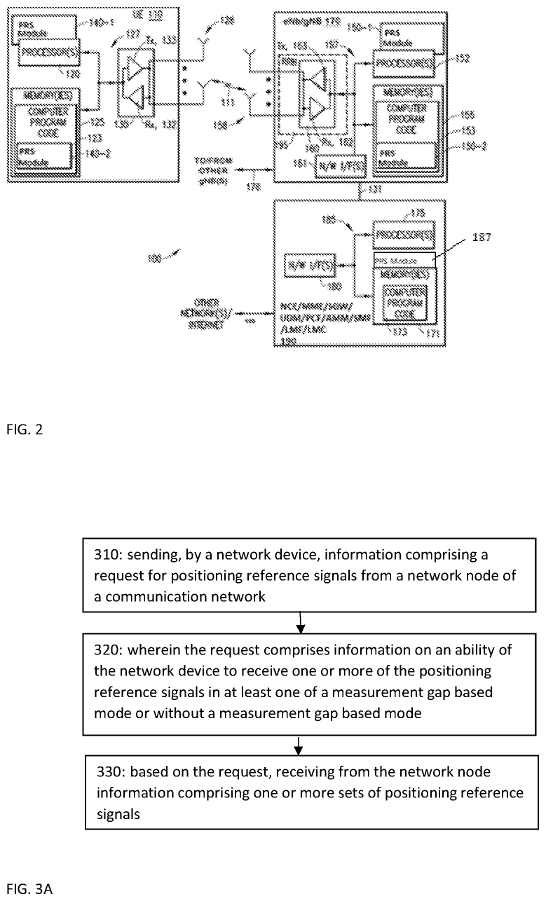

Before describing the example embodiments of the invention in further detail reference is made to FIG. 2. FIG. 2 shows a block diagram of one possible and non-limiting exemplary system in which the exemplary embodiments may be practiced.

As shown in FIG. 2, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver Rx, 132 and a transmitter Tx 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 may include a Positioning Reference Signal Module 140 (PRS Module 140) which is configured to perform the example embodiments of the invention as described herein. The PRS Module 140 may be implemented in hardware by itself of as part of the processors and/or the computer program code of the UE 110. The PRS Module 140 comprising one of or both parts 140-1 and/or 140-2, which may be implemented in a number of ways. The PRS Module 140 may be implemented in hardware as PRS Module 140-1, such as being implemented as part of the one or more processors 120. The PRS Module 140-1 may be implemented also as an integrated circuit or through other hardware such as a programmable gate array. In another example, the PRS Module 140 may be implemented as PRS Module 140-2, which is implemented as computer program code 123 and is executed by the one or more processors 120. Further, it is noted that the PRS Modules 140-1 and/or 140-2 are optional. For instance, the one or more memories 125 and the computer program code 123 may be configured, with the one or more processors 120, to cause the user equipment 110 to perform one or more of the operations as described herein. The UE 110 communicates with gNB 170 via a wireless link 111.

The gNB 170 (NR/5G Node B or possibly an evolved NB) is a base station (e.g., for LTE, long term evolution) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver Rx 162 and a transmitter Tx 163. The one or more transceivers 160 are connected to one or more antennas 158. The one or more memories 155 include computer program code 153. The gNB 170 includes a PRS Module 150 which is configured to perform example embodiments of the invention as described herein. The PRS Module 150 may comprise one of or both parts 150-1 and/or 150-2, which may be implemented in a number of ways. The PRS Module 150 may be implemented in hardware by itself or as part of the processors and/or the computer program code of the gNB 170. PRS Module 150-1, such as being implemented as part of the one or more processors 152. The PRS Module 150-1 may be implemented also as an integrated circuit or through other hardware such as a programmable gate array. In another example, the PRS Module 150 may be implemented as PRS Module 150-2, which is implemented as computer program code 153 and is executed by the one or more processors 152. Further, it is noted that the PRS Modules 150-1 and/or 150-2 are optional. For instance, the one or more memories 155 and the computer program code 153 may be configured to cause, with the one or more processors 152, the gNB 170 to perform one or more of the operations as described herein. The one or more network interfaces 161 communicate over a network such as via the links 176 and 131. Two or more gNB 170 may communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the gNB that forms the cell will perform the functions. The cell makes up part of a gNB. That is, there can be multiple cells per gNB.

The wireless network 100 may include a NCE/MME/SGW/UDM/PCF/AMM/SMF/LMF/LMC 190, which can comprise a network control element (NCE), and/or serving gateway (SGW) 190, and/or MME (Mobility Management Entity) and/or SGW (Serving Gateway) functionality, and/or user data management functionality (UDM), and/or PCF (Policy Control) functionality, and/or Access and Mobility (AMF) functionality, and/or Session Management (SMF) functionality, Location Management Function (LMF), Location Management Component (LMC) and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF/LMF/LMC 190 is configurable to perform operations in accordance with example embodiments of the invention in any of an LTE, NR, 5G and/or any standards-based communication technologies being performed or discussed at the time of this application.

The gNB 170 is coupled via a link 131 to the NCE/MME/SGW/UDM/PCF/AMM/SMF/LMF/LMC 190. The link 131 may be implemented as, e.g., an S1 interface or N2 interface. The NCE/MME/SGW/UDM/PCF/AMM/SMF/LMF/LMC 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE/MME/SGW/UDM/PCF/AMM/SMF/LMF/LMC 190 to perform one or more operations. In addition, the NCE/MME/SGW/UDM/PCF/AMM/SMF/LMF/LMC 190, as are the other devices, is equipped to perform operations of such as by controlling the UE 110 and/or gNB 170 for 5G and/or NR operations in addition to any other standards operations implemented or discussed at the time of this application.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 175 may be means for performing functions and other functions as described herein to control a network device such as the UE 110, gNB 170, and/or NCE/MME/SGW/UDM/PCF/AMM/SMF/LMF/LMC 190 as in FIG. 2. The PRS module 187 of the NCE/MME/SGW/UDM/PCF/AMM/SMF/LMF/LMC 190 may be used to perform operations in accordance with example embodiments of the invention.

It is noted that functionality(ies), in accordance with example embodiments of the invention, of any devices as shown in FIG. 2 e.g., the UE 110 and/or gNB 170 can also be implemented by other network nodes, e.g., a wireless or wired relay node (a.k.a., integrated access and/or backhaul (IAB) node). In the IAB case, UE functionalities may be carried out by MT (mobile termination) part of the IAB node, and gNB functionalities by DU (Data Unit) part of the IAB node, respectively. These devices can be linked to the UE 110 as in FIG. 2 at least via the wireless link 111 and/or via the NCE/MME/SGW/UDM/PCF/AMM/SMF/LMF/LMC 190 using link 199 to Other Network(s)/Internet as in FIG. 2.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, in addition for vehicles such as autos and/or truck and arial vehicles such as manned or unmanned arial vehicle and as well as portable units or terminals that incorporate combinations of such functions.

As similarly stated above example embodiments of the invention propose at least a method and apparatus for a UE to indicate a preference for DL PRS reception with or without a measurement gap and appropriately configure an on-demand PRS, and for a network node such as a base station to provide configurations to the UE for DL PRS reception with or without a measurement gap and appropriately configure an on-demand PRS.

Some of the inventive steps in accordance with example embodiments of the invention are summarized below with details provided herein:
UE decides to request on-demand PRS as part of a positioning session;
UE determines that it can receive the PRS in MG-less mode or not for a particular PRS resource/resource set that it will request based on one or more of the following:
   current scheduling constraints/data activity,
   PRS processing capability,
   PRS BW,
   current active BWP,
   periodicity of PRS, periodicity of MG, periodicity of PRS processing window,
   # of (positioning) measurement samples,
      Positioning measurement from UE means RSTD, RSRP, UE Rx-Tx time difference,
      The UE can perform positioning measurements is RSTD, RSRP, UE Rx-Tx time difference. In case of UE Rx-Tx time difference, the measurement can be associated with both PRS and SRS,
   DL PRS processing window;
UE requests on-demand PRS and indicates if the PRS can be received in MG-less mode or requires a MG:
   As one embodiment, the UE may indicate it can receive one set of PRS (e.g., one set of one or more TRPs/PRS resource sets) in MG-less mode and another set of PRS in MG-based mode,
   As another embodiment, the UE may also indicate the DL PRS processing window that it may use for the MG-less PRS reception:
      For example, a specific PRS resource set #1 can be tagged with (within BWP O, within window O). Similarly, PRS resource set #2—(within BWP O, within window X). This can be similarly applied to the preconfigured PRS (pre-configuration of multiple PRS resource sets/TRPs) which are requested by the UE;
   As another embodiment, the UE may also indicate the purpose of the PRS. For example, one set of on-demand PRS is for high accuracy, another on-demand PRS is for low complexity;
LMF determines based on the on-demand PRS requests, potentially from multiple UEs, the optimal PRS configuration and lowest latency (based on MG-less or MG-based preference from UE),
LMF requests on-demand PRS from gNBs and configures the UE appropriately:
   LMF may indicate to the UE the assumption of MG-less or MG-based in the configuration; and/or
UE measures PRS based on on-demand configuration in either MG-less or MG-based

Another embodiment of the idea is to allow the LMF, when pre-configuring multiple on-demand DL PRS to the UE, to indicate if it assumes if the pre-configurations have the assumption of MG-less or MG-based. The UE then determines if it needs a MG or not based on the steps outlined herein. The UE then requests the best pre-configuration PRS based on this determination.

Another embodiment of the idea is for the UE to indicate the ability/preference of the UE to perform PRS measurement in MG-less or MG-based mode without on-demand PRS. For example, a UE may have little data traffic recently and therefore indicate it can measure the PRS in MG-less mode. As another example, the UE may predict it will have a need for DL/UL data during a positioning session and therefore indicate that it may need to measure the PRS in MG-based mode. As part of this embodiment the UE may also optionally directly indicate the ability to measure in MG-less mode to the serving gNB.

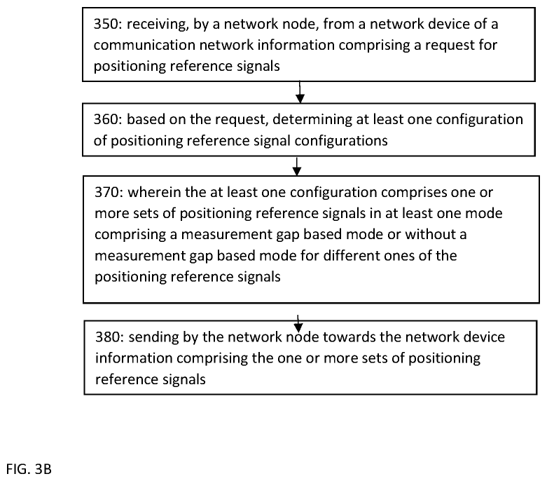

FIG. 3A illustrates operations which may be performed by a device such as, but not limited to, a network device (e.g., the UE 110 as in FIG. 2). As shown in step 310 of FIG. 3A there is sending, by a network device, information comprising a request for positioning reference signals from a network node of a communication network. As shown in step 320 of FIG. 3A wherein the request comprises information on an ability of the network device to receive one or more of the positioning reference signals in at least one of a measurement gap based mode or without a measurement gap based mode. Then as shown in step 330 of FIG. 3A there is, based on the request, receiving from the network node information comprising one or more sets of positioning reference signals.

In accordance with the example embodiments as described in the paragraph above, wherein the received one or more sets of positioning reference signals comprises based on a request from the network device at least one of a positioning reference signal in a measurement gap based mode and a positioning reference signal without a measurement gap based mode.

In accordance with the example embodiments as described in the paragraphs above, wherein the information comprises an indication of a downlink positioning reference signal processing window that the network device will use for processing a positioning reference signal without a measurement gap based mode.

In accordance with the example embodiments as described in the paragraphs above, wherein the information comprises an indication of a purpose of the positioning reference signals, and wherein the indicated purpose of the positioning reference signals is for at least one of an accuracy, latency, or a complexity associated with the positioning reference signals.

In accordance with the example embodiments as described in the paragraphs above, wherein the at least one non-transitory memory including the computer program code is configured with the at least one processor to cause the apparatus to measure by the network device the one or more sets of positioning reference signals in either the measurement gap based mode or without a measurement gap based mode.

In accordance with the example embodiments as described in the paragraphs above, wherein the at least one mode for the different ones of the positioning reference signals is based on at least one of: current scheduling constraints/data activity, positioning reference signal processing capability, positioning reference signal bandwidth, current active downlink bandwidth part, periodicity of PRS, periodicity of measurement gap pattern, periodicity of downlink PRS signal processing window, number of PRS measurement samples, or downlink positioning reference signal processing window.

In accordance with the example embodiments as described in the paragraphs above, wherein the request for positioning reference signals request comprises a request for on-demand positioning reference signals.

A non-transitory computer-readable medium (Memory(ies) 125 as in FIG. 2) storing program code (Computer Program Code 123 and/or PRS Module 140-2 as in FIG. 2), the program code executed by at least one processor (Processor(s) 120 and/or PRS Module 140-1 as in FIG. 2) to perform the operations as at least described in the paragraphs above.

In accordance with an example embodiment of the invention as described above there is an apparatus comprising: means for sending (one or more transceivers 130, Memory(ies) 125, Computer Program Code 123 and/or PRS Module 140-2, and Processor(s) 120 and/or PRS Module 140-1 as in FIG. 2), by a network device (UE 110 as in FIG. 2), information comprising a request for positioning reference signals from a network node (eNB/gNB 170 as in FIG. 2) of a communication network (Network 100 as in FIG. 2), wherein the request comprises information on an ability of the network device to receive (one or more transceivers 130, Memory(ies) 125, Computer Program Code 123 and/or PRS Module 140-2, and Processor(s) 120 and/or PRS Module 140-1 as in FIG. 2) one or more of the positioning reference signals in at least one of a measurement gap based mode or without a measurement gap based mode; based on the request, means for receiving (one or more transceivers 130, Memory(ies) 125, Computer Program Code 123 and/or PRS Module 140-2, and Processor(s) 120 and/or PRS Module 140-1 as in FIG. 2) from the network node information comprising one or more sets of positioning reference signals.

In the example aspect of the invention according to the paragraph above, wherein at least the means for sending and receiving comprises a non-transitory computer readable medium [Memory(ies) 125 as in FIG. 2] encoded with a computer program [Computer Program Code 123 and/or PRS Module 140-2 as in FIG. 2] executable by at least one processor [Processor(s) 120 and/or PRS Module 140-1 as in FIG. 2].

FIG. 3B illustrates operations which may be performed by a device such as, but not limited to, a network node (e.g., such as an LMF of the NCE/MME/SGW/UDM/PCF/AMM/SMF/LMF/LMC 190 device as in FIG. 2 and wherein at least this LMF function of this device may be incorporated into a network node such as the eNB/gNB 170 as in FIG. 2). As shown in step 350 of FIG. 3B there is receiving, by a network node, from a network device of a communication network information comprising a request for positioning reference signals. As shown in step 360 of FIG. 3B there is, based on the request, determining at least one configuration of positioning reference signal configurations. As shown in step 370 of FIG. 3B wherein the at least one configuration comprises one or more sets of positioning reference signals in at least one mode comprising a measurement gap based mode or without a measurement gap based mode for different ones of the positioning reference signals. Then as shown in step 380 of FIG. 3B there is sending by the network node towards the network device information comprising the one or more sets of positioning reference signals.

In accordance with the example embodiments as described in the paragraph above, wherein the request comprises information on an ability of the network device to receive one or more of the positioning reference signals in at least one of a measurement gap based mode or without a measurement gap based mode.

In accordance with the example embodiments as described in the paragraphs above, wherein the information comprises an indication of a downlink positioning reference signal processing window to be used by the network device for processing a positioning reference signal without a measurement gap based mode.

In accordance with the example embodiments as described in the paragraphs above, wherein the information comprises an indication of a purpose of the positioning reference signals, and wherein the indicated purpose of the positioning reference signals is for at least one of an accuracy, latency, or a complexity associated with the positioning reference signals.

In accordance with the example embodiments as described in the paragraphs above, wherein the request for positioning reference signals from the network device are based on positioning reference signals in at least one of a measurement gap based mode or without a measurement gap based mode predetermined by the network node for the network device.

In accordance with the example embodiments as described in the paragraphs above, wherein the information sent towards the network device comprises an indication that determining the one or more sets of positioning reference signal using the measurement gap based mode or without a measurement gap based mode are based on a predetermination by the network node of requirements by the network device.

A non-transitory computer-readable medium (Memory(ies) 171, storing Computer Program Code 173 executed by at least one processor (Processor(s) 175 and/or PRS Module 187 as in FIG. 2 and also if incorporated into a base station such as the eNB/gNB 170 as in FIG. 2 then also Memory(ies) 155 as in FIG. 2) storing program code (Computer Program Code 153 and/or PRS Module 150-2 as in FIG. 2), the program code executed by at least one processor (Processor(s) 152 and/or PRS Module 150-1 as in FIG. 2) to perform the operations as at least described in the paragraphs above.

In accordance with an example embodiment of the invention as described above there is an apparatus comprising: means for receiving (NW I/Fs Memory(ies) 171, Computer Program Code 173 storing Computer Program Code 173 executed by at least one processor (Processor(s) 175 and/or PRS Module 187 as in FIG. 2 and also if incorporated into a base station such as the eNB/gNB 170 as in FIG. 2 then also remote radio head (RRH) 195, Memory(ies) 155, Computer Program Code 153 and/or PRS Module 150-2, and Processor(s) 152 and/or PRS Module 150-1 as in FIG. 2), by a network node (LMF of the NCE/MME/SGW/UDM/PCF/AMM/SMF/LMF/LMC 190 as in FIG. 2 and/or eNB/gNB 170 as in FIG. 2), from a network device (UE 110 as in FIG. 2) of a communication network (Network 100 as in FIG. 2) information comprising a request for positioning reference signals; means, based on the request, for determining (NW I/Fs Memory(ies) 171, Computer Program Code 173 storing Computer Program Code 173 executed by at least one processor (Processor(s) 175 and/or PRS Module 187 as in FIG. 2 and also if incorporated into a base station such as the eNB/gNB 170 as in FIG. 2 then also remote radio head (RRH) 195, Memory(ies) 155, Computer Program Code 153 and/or PRS Module 150-2, and Processor(s) 152 and/or PRS Module 150-1 as in FIG. 2) at least one configuration of positioning reference signal configurations, wherein the at least one configuration comprises one or more sets of positioning reference signals in at least one mode comprising a measurement gap based mode or without a measurement gap based mode for different ones of the positioning reference signals; and means for sending (NW I/Fs Memory(ies) 171, Computer Program Code 173 storing Computer Program Code 173 executed by at least one processor (Processor(s) 175 and/or PRS Module 187 as in FIG. 2 and also if incorporated into a base station such as the eNB/gNB 170 as in FIG. 2 then also remote radio head (RRH) 195, Memory(ies) 155, Computer Program Code 153 and/or PRS Module 150-2, and Processor(s) 152 and/or PRS Module 150-1 as in FIG. 2) by the network node towards the network device information comprising the one or more sets of positioning reference signals.

In the example aspect of the invention according to the paragraph above, wherein at least the means for receiving, determining, and sending comprises a non-transitory computer readable medium [Memory(ies) 171 and/or Memory(ies) 155 as in FIG. 2] encoded with a computer program [Computer Program Code 173 and/or Computer Program Code 153 and/or PRS Module 187 and/or PRS Module 150-2 as in FIG. 2] executable by at least one processor [at least one processor (Processor(s) 175 and/or Processor(s) 152 and/or PRS Module 150-1 as in FIG. 2].

It is noted that advantages of example embodiments of the invention include:
Reduced positioning latency, and
Improved network efficiency

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” as may be used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-28. (canceled)

29. An apparatus comprising:
at least one processor; and
at least one non-transitory memory including computer program code, where the at least one non-transitory memory and the computer program code are configured, with the at least one processor, to cause the apparatus to at least:
send, by a network device, information comprising an indication of an ability of the network device to receive one or more of positioning reference signals in a mode that does not require a measurement gap for reception of positioning reference signals;
based on the indication, receive from a network node of a communication network information comprising one or more sets of positioning reference signals.

30. The apparatus of claim 29, wherein the received one or more sets of positioning reference signals comprises, based on the indication from the network device, a positioning reference signal receivable in the mode that that does not require a measurement gap.

31. The apparatus of claim 29, wherein the information comprising the indication comprises a further indication of a downlink positioning reference signal processing window that the network device will use for processing a positioning reference signal in the mode that that does not require a measurement gap.

32. The apparatus of claim 29, wherein the information comprising the indication comprises a further indication of a purpose of the positioning reference signals, and wherein the indicated purpose of the positioning reference signals is for at least one of an accuracy, latency, or a complexity associated with the positioning reference signals.

33. The apparatus of claim 29, wherein the at least one non-transitory memory including the computer program code is configured with the at least one processor to cause the apparatus to measure by the network device the one or more sets of positioning reference signals in the mode that that does not require a measurement gap.

34. The apparatus of claim 29, wherein the mode for different ones of the positioning reference signals is based on at least one of:
current scheduling constraints,
data activity,
positioning reference signal processing capability,
positioning reference signal bandwidth,
current active downlink bandwidth part,
periodicity of positioning reference signals,
periodicity of measurement gap pattern,
periodicity of downlink positioning reference signal signal processing window,
number of positioning reference signal measurement samples, or
downlink positioning reference signal processing window.

35. The apparatus of claim 29, wherein the indication for positioning reference signals comprises a request for on-demand positioning reference signals.

36. A method, comprising:
sending, by a network device, information comprising an indication of an ability of the network device to receive one or more of positioning reference signals in a mode that does not require a measurement gap for the reception of the positioning reference signals;
based on the indication, receiving from a network node of a communication network information comprising one or more sets of positioning reference signals.

37. The method of claim 36, wherein the received one or more sets of positioning reference signals comprises, based on the indication from the network device, a positioning reference signal receivable in the mode that that does not require a measurement gap.

38. The method of claim 36, wherein the information comprising the indication comprises a further indication of a downlink positioning reference signal processing window that the network device will use for processing a positioning reference signal in the mode that that does not require a measurement gap.

39. The method of claim 36, wherein the information comprising the indication comprises a further indication of a purpose of the positioning reference signals, and wherein the indicated purpose of the positioning reference signals is for at least one of an accuracy, latency, or a complexity associated with the positioning reference signals.

40. The method of claim 36, further comprising:
measuring by the network device the one or more sets of positioning reference signals in the mode that that does not require a measurement gap.

41. The method of claim 36, wherein the mode for different ones of the positioning reference signals is based on at least one of:
current scheduling constraints,
data activity,
positioning reference signal processing capability,
positioning reference signal bandwidth,
current active downlink bandwidth part,
periodicity of positioning reference signals,
periodicity of measurement gap pattern,
periodicity of downlink positioning reference signal signal processing window,
number of positioning reference signal measurement samples, or
downlink positioning reference signal processing window.

42. The method of claim 36, wherein the indication for positioning reference signals comprises a request for on-demand positioning reference signals.

43. An apparatus comprising:
at least one processor; and
at least one non-transitory memory including computer program code, where the at least one non-transitory memory and the computer program code are configured, with the at least one processor, to cause the apparatus to at least:
receive, by a network node, from a network device of a communication network information comprising an indication of an ability of the network device to receive one or more of positioning reference signals in a mode that does not require a measurement gap for the reception of the positioning reference signals;
based on the indication, determine at least one configuration of positioning reference signal configurations, wherein the at least one configuration comprises one or more sets of positioning reference signals for reception in at least one of: the mode that does not require a measurement gap or a mode that does require a measurement gap; and
send by the network node towards the network device information comprising the one or more sets of positioning reference signals.

44. The apparatus of claim 43, wherein the information comprising the indication comprises a further indication of a downlink positioning reference signal processing window to be used by the network device for processing a positioning reference signal in the mode that that does not require measurement gap.

45. The apparatus of claim 43, wherein the information comprising the indication comprises a further indication of a purpose of the positioning reference signals, and wherein the indicated purpose of the positioning reference signals is for at least one of an accuracy, latency, or a complexity associated with the positioning reference signals.

46. The apparatus of claim 43, wherein determining the at least one configuration comprises determining an optimal positioning reference signal configuration with lowest latency based on the two modes.
